(19) United States
(12) Patent Application Publication
(10) Pub. No.: US 2020/0306007 A1
(43) Pub. Date: Oct. 1, 2020

(54) Pump Structure of Portable Oral Irrigator and Portable Oral Irrigator Comprising Same

(71) Applicant: Xudong WANG, Foshan City (CN)

(72) Inventor: Xudong WANG, Foshan City (CN)

(21) Appl. No.: 16/482,713

(22) PCT Filed: Feb. 7, 2018
(86) PCT No.: PCT/CN2018/075549

§ 371 Date: Aug. 1, 2019

(30) Foreign Application Priority Data
Mar. 11, 2017 (CN) 201710143205.9

(51) Int. Cl. A61C 1/00; B01D 35/30; A61C 17/02; F04B 17/03

(52) U.S. Cl. CPC A61C 1/0092; B01D 35/30; B01D 2201/40; F04B 17/03; A61C 17/0202

(57) ABSTRACT

A pump structure of a portable oral irrigator, the oral irrigator main engine comprises a housing and a pump assembly; the pump assembly is disposed within the housing and is provided with a pump body, a driving motor, a water outlet provided corresponding to the water outlet nozzle, and a water inlet provided corresponding to the water inlet nozzle are disposed on the housing; an output shaft of the driving motor is drivingly connected to the pump body by means of a spur gear and a contrate gear; the pumping piston head is disposed in one end of the pump cylinder, and the other two ends of the pump cylinder are communicated with the water outlet nozzle and the water inlet nozzle; one end of the piston rod is connected with the pumping piston head; and the other end of the piston rod eccentrically and rotationally cooperates with the contrate gear.

### BACKGROUND OF THE INVENTION

The present invention relates to a portable oral irrigator, and more particularly, to a pump structure of a portable oral irrigator and a portable oral irrigator comprising same.

At present, a portable oral irrigator generally comprises an oral irrigator main engine, the oral irrigator main engine comprises a housing and a pump assembly, the pump is disposed within the housing, and the housing is provided with a water inlet and a water outlet corresponding to the pump. Since the pump in the current oral irrigator main engine is a bought-in component, a model of the portable oral irrigator is designed according to the pump on the current market, thus bringing great limitations to the design of the portable oral irrigator. In addition, since a quality of the bought-in pump is difficult to be controlled, and a volume of the pump is large, the portable oral irrigator is unreliable in operation and has a large volume.

### BRIEF SUMMARY OF THE INVENTION

The present invention is intended to overcome the defects of the prior art above, and provide a pump structure of a portable oral irrigator and a portable oral irrigator comprising same with simple and reasonable structure, reliable operation and small volume.

The object of the present invention is realized as follows.

For a pump structure of a portable oral irrigator, the portable oral irrigator comprises: an oral irrigator main engine, the oral irrigator main engine comprises a housing and a pump assembly, the pump assembly is disposed within the housing and is provided with a pump body, a driving motor, a water outlet nozzle and a water inlet nozzle, a water outlet provided corresponding to the water outlet nozzle, and a water inlet provided corresponding to the water inlet nozzle are disposed on the housing, wherein the driving motor is vertically disposed, an output shaft of the driving motor is drivingly connected with the pump body by means of a spur gear and a contrate gear, the contrate gear is vertically and rotationally disposed within the housing, the pump body comprises a pump cylinder, a piston rod and a pumping piston head, the pump cylinder is a T-branch pipe, the pumping piston head is disposed in one end of the pump cylinder, the other two ends of the pump cylinder are communicated with the water outlet nozzle and the water inlet nozzle, one end of the piston rod is connected with the pumping piston head, and the other end of the piston rod eccentrically and rotationally cooperates with the contrate gear.

The object of the present invention can also be solved by following technical solutions.

As a more specific solution, an end surface of the contrate gear is provided with an eccentric shaft, the other end of the piston rod is provided with a shaft sleeve, and the shaft sleeve is sheathed on the eccentric shaft.

The water outlet is located at a top end of the housing, and the water outlet nozzle, the pump cylinder and the driving motor are sequentially disposed from top to bottom.

The housing is in a sleeve shape with an open bottom end, the water inlet and the water outlet are respectively disposed at a top end and an outer periphery of the housing, a storage battery, a control circuit board and a wireless charging module are also disposed within the housing, the storage battery, the control circuit board, the wireless charging module and the pump assembly are packaged within the housing through a bottom cover, and the bottom cover is hermetically connected with a lower end of the housing; the storage battery is respectively electrically connected with the control circuit board and the wireless charging module, and the control circuit board is electrically connected with the driving motor; and the storage battery and the wireless charging module are sequentially disposed below the driving motor.

A front bracket and a rear bracket are also disposed within the housing, the pump assembly, the storage battery and the wireless charging module are located between the front bracket and the rear bracket, and the control circuit board is disposed at a front side of the front bracket.

The control circuit board is provided with a button control switch, and the housing is provided with a waterproof button corresponding to the button control switch. The start-up, shut-down and operation mode switching of the portable oral irrigator are all completed through the button control switch, so that the portable oral irrigator is simpler and easy to use.

The present invention also provides a portable oral irrigator comprising the pump structure of a portable oral irrigator above and a charging seat, the charging seat comprises a seat body, a wireless charging circuit and a power wire, a top part of the seat body is at least provided with a main engine positioning groove for placing the oral irrigator main engine, the wireless charging circuit is disposed within the seat body and is electrically connected with one end of the power wire, the other end of the power wire extends out of the seat body and is connected with a plug, an outer periphery of the seat body is provided with a winding groove for winding the power wire, and a bottom part of the seat body is provided with a plug accommodating groove for placing the plug.

The portable oral irrigator also comprises a flexible pipe bracket and a pumping flexible pipe, a pipe winding groove is disposed outside the flexible pipe bracket, one end of the pumping flexible pipe is connected with a filter head, the pipe winding groove is provided with a filter head anti-release clamping position corresponding to the filter head, and is also provided with a flexible pipe anti-release clamping position corresponding to the other end of the pumping flexible pipe, the pumping flexible pipe is wound outside the pipe winding groove, the filter head at one end of the pumping flexible pipe is clamped in the filter head anti-release clamping position, and the other end of the pumping flexible pipe is clamped in the flexible pipe anti-release clamping position.

An inner wall of the water inlet is provided with a sealing ring which is clamped between the water inlet nozzle and an inner wall of the housing, and a center of the sealing ring is provided with a sleeve pipe extending inside the water inlet nozzle; a nozzle can be disposed on the water outlet of the oral irrigator main engine, the nozzle comprises a nozzle body, the nozzle body sequentially comprises a connecting head, a nozzle handle and a nozzle head from bottom to top, the nozzle body is internally provided with a water flow channel, the nozzle head is provided with an injection hole communicated with the water flow channel, the nozzle head is externally provided with a soft sleeve, the soft sleeve covers to an outer periphery of the nozzle head and a top end thereof, and the soft sleeve is provided with a relief hole corresponding to the injection hole.

An oral brush can be disposed on the water outlet of the oral irrigator main engine, the oral brush comprises a brush body, two ends of the brush body are respectively provided with a connecting head and a brush head, the brush body is internally provided with a water flow channel, one side of the brush head is provided with a water spray hole and a conical bristle bundle, the connecting head and the water spray hole are both communicated with the water flow channel, the conical bristle bundle is composed of a plurality of bristles, one end of the conical bristle bundle is disposed in the brush head, and the other end of the conical bristle bundle is conical.

The present invention has the beneficial effects as follow:

(1) according to the present invention, an eccentric drive mechanism controls the pumping piston head to continuously reciprocate in the pump cylinder, thus realizing continuous pumping and achieving the purpose of reliable operation; and

(2) internal components of the present invention have reasonable layout, thus saving the space and making the product smaller in volume.

### BRIEF DESCRIPTION OF THE DRAWINGS

FIG. 1 is a decomposed structure diagram of an embodiment of the present invention.

FIG. 2 is a structure diagram of another angle of a local structure of FIG. 1.

FIG. 3 is a structure diagram of a front view of the present invention.

FIG. 4 is a structure diagram of an A-A sectional view of FIG. 3.

FIG. 5 is an enlarged structure diagram of a B part in FIG. 4.

FIG. 6 is a decomposed structure diagram of a water inlet nozzle, a sealing ring and a quick connector in the present invention.

FIG. 7 is a structure diagram of another angle of FIG. 6.

FIG. 8 is a structure diagram of a state of a corresponding portable oral irrigator according to the present invention.

FIG. 9 is a decomposed structure diagram of a charging seat in FIG. 8.

FIG. 10 is a structure diagram of an angle of a seat body in FIG. 8.

FIG. 11 is a structure diagram of a use state of a flexible pipe bracket in FIG. 8.

FIG. 12 is a structure diagram of an angle of a filter head in FIG. 8.

FIG. 13 is a structure diagram of another angle of the filter head in FIG. 8.

FIG. 14 is a structure diagram of the flexible pipe bracket in FIG. 8.

FIG. 15 is a structure diagram of a front view of a brush body in FIG. 8.

FIG. 16 is a structure diagram of a C-C sectional view of FIG. 15.

FIG. 17 is a structure diagram of a front view of a nozzle in FIG. 8.

FIG. 18 is a structure diagram of a D-D sectional view of FIG. 17.

### DETAILED DESCRIPTION OF THE INVENTION

The present invention is further described hereinafter with reference to the drawings and the embodiments.

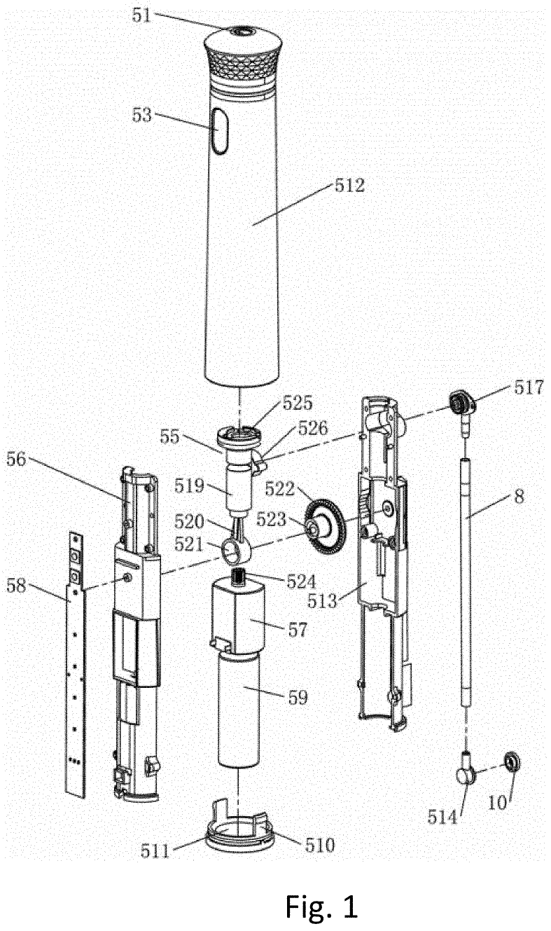

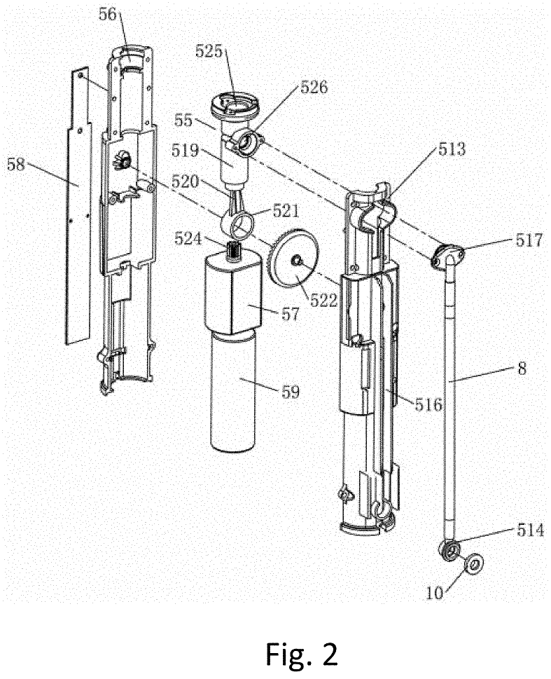

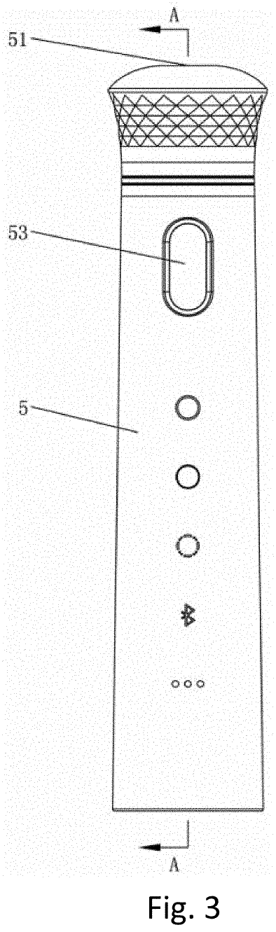

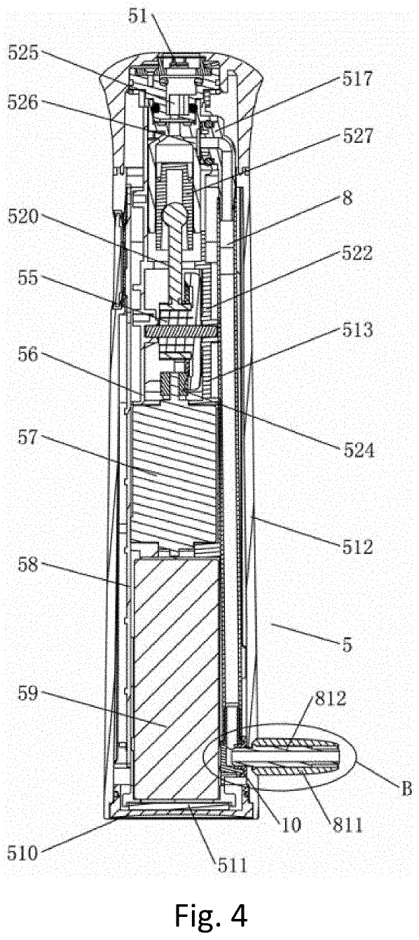

With reference to FIG. 1 to FIG. 4, for a pump structure of a portable oral irrigator, the portable oral irrigator comprises an oral irrigator main engine 5, the oral irrigator main engine 5 comprises a housing 512 and a pump assembly, the pump assembly is disposed within the housing 512 and is provided with a pump body 55, a driving motor 57, a water outlet nozzle 525 and a water inlet nozzle 514, a water outlet 51 provided corresponding to the water outlet nozzle 525, and a water inlet 52 provided corresponding to the water inlet nozzle 514 are disposed on the housing 512, the driving motor 57 is vertically disposed, an output shaft of the driving motor 57 is drivingly connected with the pump body 55 by means of a spur gear 524 and a contrate gear 522, the contrate gear 522 is vertically and rotationally disposed within the housing 512, the pump body 55 comprises a pump cylinder 519, a piston rod 520 and a pumping piston head 527, the pump cylinder 519 is a T-branch pipe, the pumping piston head 527 is disposed in one end of the pump cylinder 519, the other two ends of the pump cylinder 519 are communicated with the water outlet nozzle 525 and the water inlet nozzle 514, one end of the piston rod 520 is connected with the pumping piston head 527, and the other end of the piston rod 520 eccentrically and rotationally cooperates with the contrate gear 522.

An end surface of the contrate gear 522 is provided with an eccentric shaft 523, the other end of the piston rod 520 is provided with a shaft sleeve 521, and the shaft sleeve 521 is sheathed on the eccentric shaft 523.

The water outlet 51 is located at a top end of the housing 512, and the water outlet nozzle 525, the pump cylinder 519 and the driving motor 57 are sequentially disposed from top to bottom.

The housing 512 is in a sleeve shape with an open bottom end, the water inlet 52 and the water outlet 51 are respectively disposed at a top end and an outer periphery of the housing 512, a storage battery 59, a control circuit board 58 and a wireless charging module 511 are also disposed within the housing 512, the storage battery 59, the control circuit board 58, the wireless charging module 511 and the pump assembly are packaged within the housing 512 by means of a bottom cover 510, and the bottom cover 510 is hermetically connected with a lower end of the housing 512; the storage battery 59 is respectively electrically connected with the control circuit board 58 and the wireless charging module 511, and the control circuit board 58 is electrically connected with the driving motor 57; and the storage battery 59 and the wireless charging module 511 are sequentially disposed below the driving motor 57.

A front bracket 56 and a rear bracket 513 are also disposed within the housing 512, the pump assembly, the storage battery 59 and the wireless charging module 511 are located between the front bracket 56 and the rear bracket 513, and the control circuit board 58 is disposed at a front side of the front bracket 56.

The control circuit board 58 is provided with a button control switch, and the housing 512 is provided with a waterproof button 53 corresponding to the button control switch.

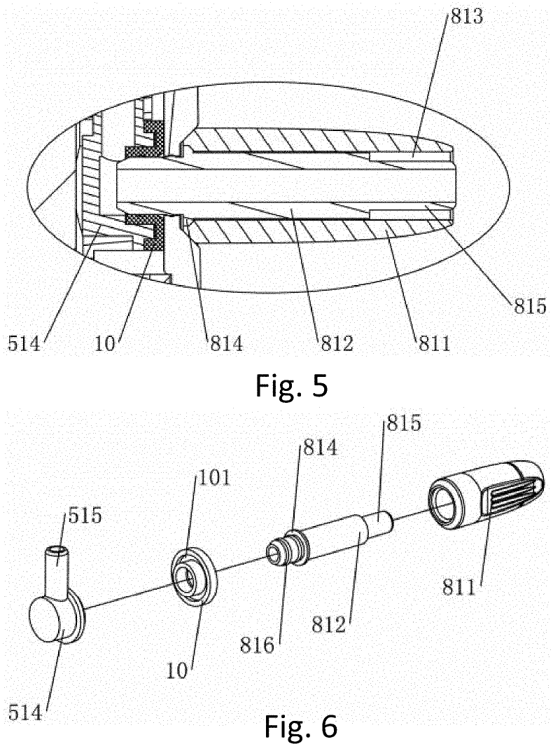

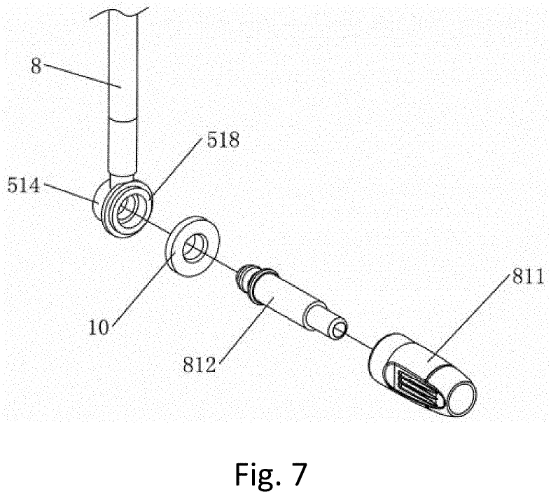

With reference to FIG. 5 to FIG. 7, an inner wall of the water inlet 52 is provided with a sealing ring 10 which is clamped between the water inlet nozzle 514 and an inner wall of the housing 512, and a center of the sealing ring 10 is provided with a sleeve pipe 102 extending inside the water inlet nozzle 514.

One side of the water inlet nozzle 514 facing the housing 512 is provided with a convex ring 518, an inside surface of the sealing ring 10 is provided with an annular concave groove 101 corresponding to the convex ring 518, and the convex ring 518 is inserted into the annular concave groove 101.

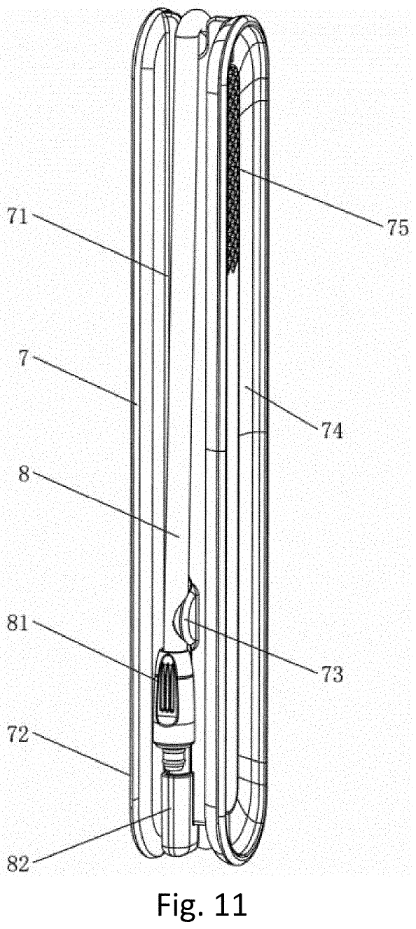

The portable oral irrigator also comprises a pumping flexible pipe 8 (referring to FIG. 11) and a quick connector 81, the quick connector 81 comprises a pipe head 812 and a locking sleeve 811, the locking sleeve 811 is sheathed outside the pipe head 812, the pumping flexible pipe 8 is connected with one end of the pipe head 812 and is clamped between the pipe head 812 and the locking sleeve 811, and the other end of the pipe head 812 extends out of the locking sleeve 811 and is inserted with the sleeve pipe 102 of the sealing ring 10.

An outer periphery of one end of the pipe head 812 is provided with a concave surface 815, the pumping flexible pipe 8 is sheathed outside the concave surface 815, and an outer periphery of the other end of the pipe head 812 is provided with a limiting flange 814 which is in limiting fit with a port of the locking sleeve 811.

The outer periphery of the other end of the pipe head 812 is also provided with a pre-tightening annular rib 816 corresponding to the sleeve pipe 102 of the sealing ring 10.

The water inlet nozzle 514 is also provided with a bypass port 515, and the bypass port 515 is connected with the pump body 55 by means of a water pipe 20 and a connecting head 517. A back surface of the rear bracket 513 is provided with a water pipe positioning groove 516 corresponding to the water pipe 20.

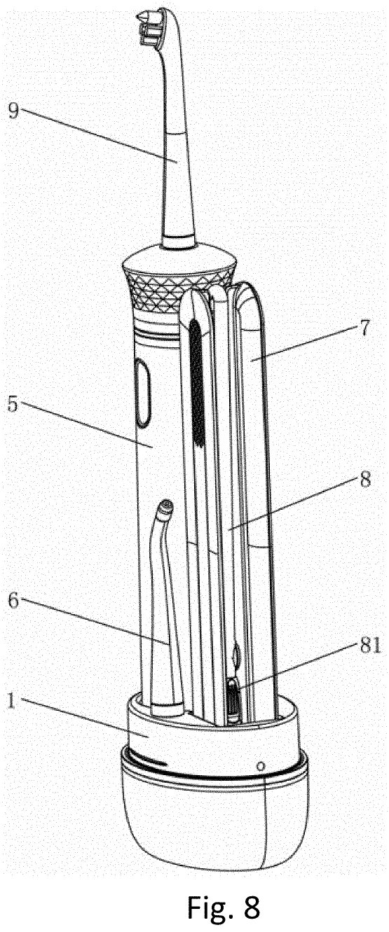

With reference to FIG. 8, the oral irrigator main engine 5 is disposed on a charging seat which can also be provided with a flexible pipe bracket 7, a nozzle 6 and etc.

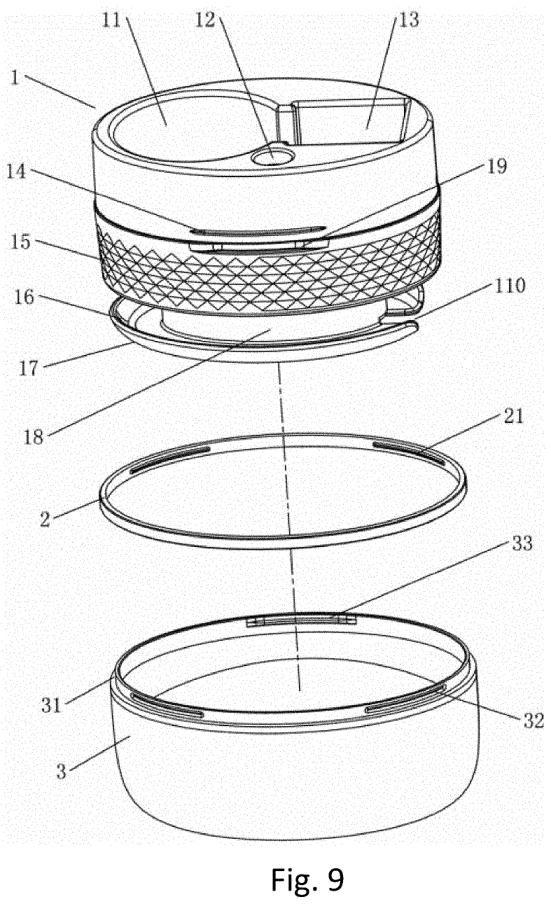

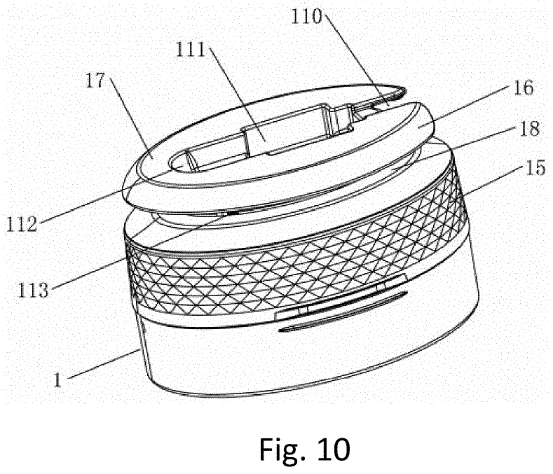

With reference to FIG. 9 and FIG. 10, the charging seat comprises a seat body 1, a wireless charging circuit and a power wire, a top part of the seat body 1 is provided with a main engine positioning groove 11 for placing the oral irrigator main engine 5, a nozzle positioning groove 12 for placing the nozzle 6, and a bracket positioning groove 13 for placing the flexible pipe bracket 7, the wireless charging circuit is disposed within the seat body 1 and is electrically connected with one end of the power wire, the other end of the power wire extends out of the seat body 1 and is connected with a plug, the outer periphery of the seat body 1 is provided with a winding groove 18 for winding the power wire, and a bottom part of the seat body 1 is provided with a plug accommodating groove 111 for placing the plug. The plug is a USB plug. A side wall of the winding groove 18 of the seat body 1 is provided with a wire through hole 113 corresponding to the power wire, and one end of the power wire extends inside the seat body 1 through the wire through hole 113 to be fixedly and conductively connected with an input end of the wireless charging circuit.

A lower side of the winding groove 18 is provided with a cover plate 17, a surface of the cover plate 17 is provided with a wire through opening 110 which penetrates through upper and lower sides of the cover plate 17 and is communicated with the plug accommodating groove 111, one side of the plug accommodating groove 111 is provided with a finger relief groove 112, and the finger relief groove 112 is communicated with the plug accommodating groove 111. An edge of the cover plate 17 is provided with an upper flanging 16, and the upper flanging 16 is in arc transition with the cover plate 17.

A lower part of the seat body 1 is also provided with a lower cover 3, and the winding groove 18 and the plug accommodating groove 111 are covered inside the lower cover 3. An outer periphery of a top edge of the lower cover 3 is provided with a positioning step 31, the positioning step 31 is provided with a decorative ring 2, an inner wall of the decorative ring 2 and a side wall of the positioning step 31 are respectively provided with a first convex rib 21 and a first concave groove 32, and after the decorative ring 2 cooperates with the positioning step 31, the first convex rib 21 and the first concave groove 32 are buckled with each other. An inner wall of an opening of the lower cover 3 is provided with a second convex rib 33, the outer periphery of the seat body 1 is provided with a concave second groove 19 corresponding to the opening of the lower cover 3, and when the lower cover 3 cooperates with the seat body 1 in place, the second convex rib 33 is buckled with the second concave groove 19.

The outer periphery of the seat body 1 is also provided with a decorative texture 15, and the top part of the seat body 1 is also provided with the nozzle positioning groove 12 for placing the nozzle 6 and the bracket positioning groove 13 for placing the flexible pipe bracket 7.

An upper part of the seat body 1 is also provided with a cover cup (not shown in the drawing). An inner wall of a cup mouth of the cover cup is provided with a third concave groove, the outer periphery of the seat body 1 is provided with a third convex rib 14 corresponding to the cup mouth of the cover cup, and when the cover cup cooperates with the seat body 1 in place, the third concave groove is buckled with the third convex rib 14.

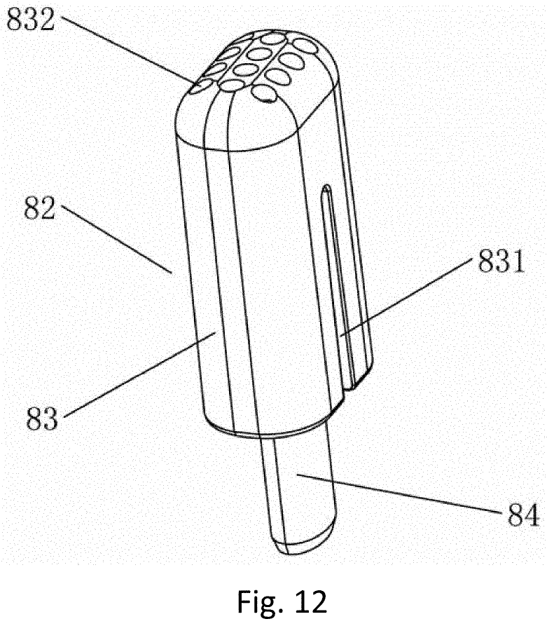

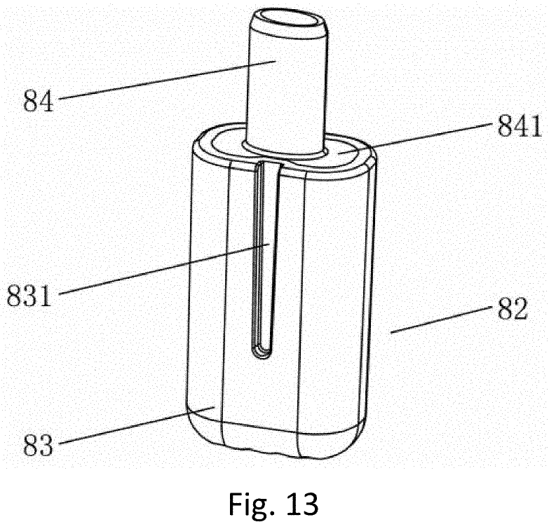

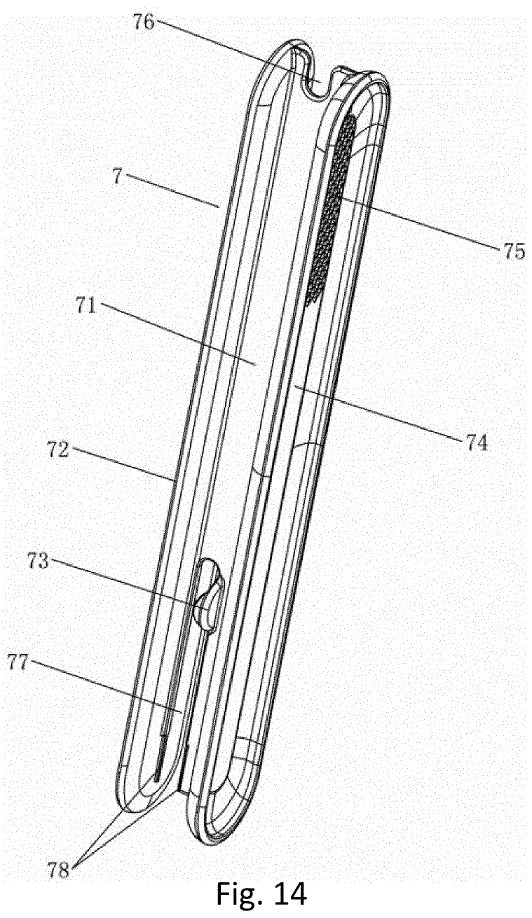

With reference to FIG. 11 to FIG. 14, a pipe winding groove is disposed outside the flexible pipe bracket 7, one end of the pumping flexible pipe 8 is connected with a filter head 82, the pipe winding groove is provided with a filter head anti-release clamping position 78 corresponding to the filter head 82, and is also provided with a flexible pipe anti-release clamping position 73 corresponding to the other end of the pumping flexible pipe 8, the pumping flexible pipe 8 is wound outside the pipe winding groove, the filter head 82 at one end of the pumping flexible pipe 8 is clamped in the filter head anti-release clamping position 78, and the other end of the pumping flexible pipe 8 is clamped in the flexible pipe anti-release clamping position 73.

The flexible pipe bracket 7 is composed of a strip-shaped first side plate 72, a second side plate 74 and a middle connecting plate 71, left and right ends of the middle connecting plate 71 are respectively connected with the first side plate 72 and the second side plate 74 to form an I-shaped structure, and an inside of the I-shaped structure forms the pipe winding groove; and upper and lower ends of the middle connecting plate 71 are respectively provided with a first flexible pipe clamping groove 76 and a second flexible pipe clamping groove 77.

The first flexible pipe clamping groove 76 and the second flexible pipe clamping groove 77 are staggered left and right. The second flexible pipe clamping groove 77 is provided with the filter head anti-release clamping position 78 and the flexible pipe anti-release clamping position 73.

An outer side of one end of the flexible pipe bracket 7 is provided with an anti-skid pattern 75.

The filter head 82 comprises a housing 83 and a filter element 841, the housing 83 is wrapped outside the filter element 841 and is provided with a water inlet hole 832 corresponding to the filter element 841, and an insertion groove 831 is disposed in a surface of the housing 83; and one end of the filter element 841 is provided with a water outlet nozzle 84 which extends out of the housing 83 and is connected with the pumping flexible pipe 8.

The filter head anti-release clamping position 78 is a positioning convex rib which is in insertion fit with an insertion groove 831 of the filter head 82, and the positioning convex rib is disposed on two sides of an opening of the second flexible pipe clamping groove 77.

The flexible pipe anti-release clamping position 73 is a hook-shaped cantilever, and the pumping flexible pipe 8 is clamped inside the hook-shaped cantilever.

The other end of the pumping flexible pipe 8 is connected with a quick connector 81.

When the pumping flexible pipe 8 is wound, the filter head 82 is firstly clamped in the filter head anti-release clamping position 78, then the pumping flexible pipe 8 is wound along an up-down direction of the middle connecting plate 71, and the other end of the pumping flexible pipe 8 is finally buckled into the flexible pipe anti-release clamping position 73.

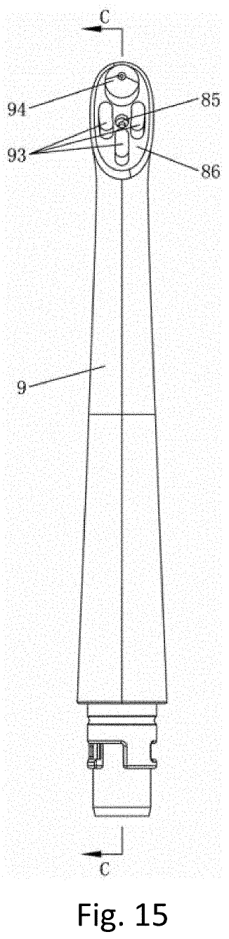

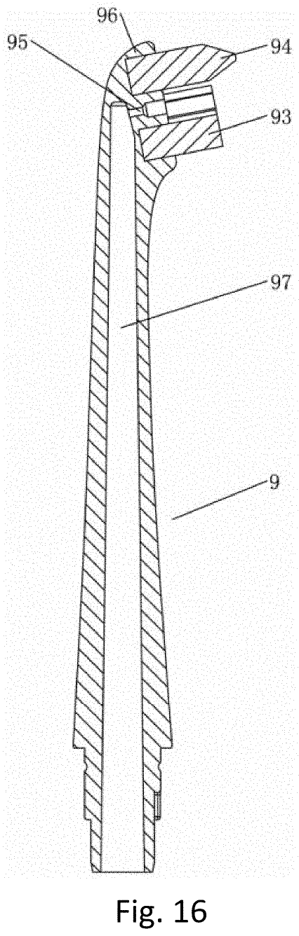

With reference to FIG. 15 and FIG. 16, an oral brush can be disposed on the water outlet 51 of the oral irrigator main engine 5, the oral brush comprises a brush body 9, two ends of the brush body 9 are respectively provided with a connecting head 91 and a brush head 96, wherein the brush body 9 is internally provided with a water flow channel 97, one side of the brush head 96 is provided with a water spray hole 95 and a conical bristle bundle 94, the connecting head 91 and the water spray hole 95 are both communicated with the water flow channel 97, the conical bristle bundle 94 is composed of a plurality of bristles, one end of the conical bristle bundle 94 is disposed in the brush head 96, and the other end of the conical bristle bundle 94 is conical.

One side of the brush head 96 is also provided with a plane bristle bundle 93, the plane bristle bundle 93 is composed of a plurality of bristles, one end of the plane bristle bundle 93 is disposed in the brush head 96, and the other end of the plane bristle bundle 93 is planar.

The conical bristle bundle 94 is located at an upper end of the brush head 96, the plane bristle bundle 93 is provided with three bundles and is located below the conical bristle bundle 94, and the conical bristle bundle 94 and the plane bristle bundle 93 surround an outer periphery of the water spray hole 95.

A diameter of an inner end of the water spray hole 95 is smaller than a diameter of an outer end.

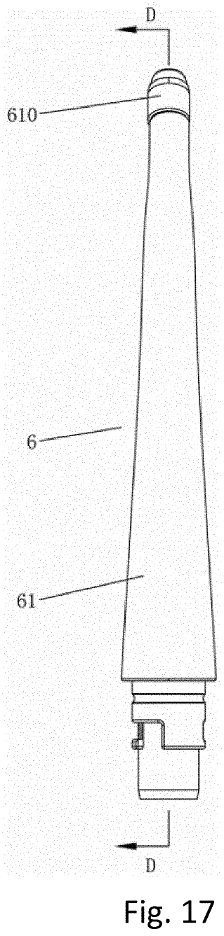

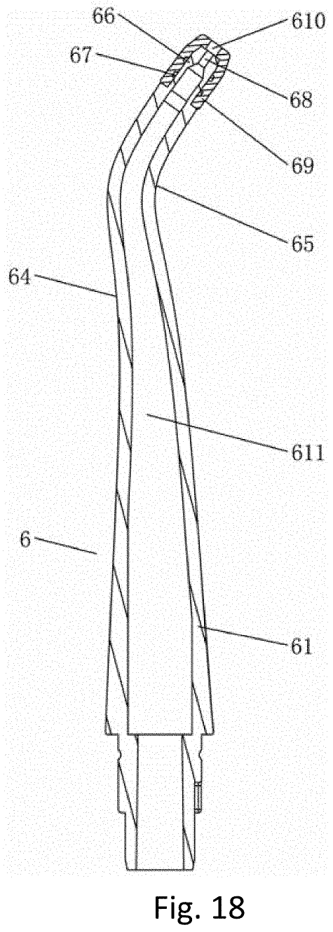

With reference to FIG. 17 and FIG. 18, a nozzle can be disposed on the water outlet 51 of the oral irrigator main engine 5, the nozzle comprises a nozzle body 6, the nozzle body 6 sequentially comprises a connecting head 63, a nozzle handle 61 and a nozzle head 66 from bottom to top, the nozzle body 6 is internally provided with a water flow channel 611, the nozzle head 66 is provided with an injection hole 68 communicated with the water flow channel 611, the nozzle head 66 is externally provided with a soft sleeve 69, the soft sleeve 69 covers to an outer periphery of the nozzle head 66 and a top end thereof, the soft sleeve 69 is provided with a relief hole 610 corresponding to the injection hole, and a diameter of the relief hole 610 is larger than a diameter of the injection hole 68. The soft sleeve 69 is a silicone sleeve.

An outer periphery of the nozzle head 66 is provided with an interference rib 67, and the soft sleeve 69 is sheathed outside the nozzle head 66 and tightly cooperates with the interference rib 67.

The nozzle handle 61 is provided with two bending sections from bottom to top, which are respectively a lower bending section 64 and an upper bending section 65, and a bending angle of the lower bending section 64 is smaller than a bending angle of the upper bending section 65. Bending directions of the two bending sections are opposite, and the water flow channel 611 is synchronously bent corresponding to the bending section.

1. A pump structure of a portable oral irrigator, the portable oral irrigator comprises an oral irrigator main engine (5), the oral irrigator main engine (5) comprises a housing (512) and a pump assembly, the pump assembly is disposed within the housing (512) and is provided with a pump body (55), a driving motor (57), a water outlet nozzle (525) and a water inlet nozzle (514), a water outlet (51) provided corresponding to the water outlet nozzle (525), and a water inlet (52) provided corresponding to the water inlet nozzle (514) are disposed on the housing (512), the driving motor (57) is vertically disposed, an output shaft of the driving motor (57) is drivingly connected with the pump body (55) by means of a spur gear (524) and a contrate gear (522), the contrate gear (522) is vertically and rotationally disposed within the housing (512), the pump body (55) comprises a pump cylinder (519), a piston rod (520) and a pumping piston head (527), the pump cylinder (519) is a T-branch pipe, the pumping piston head (527) is disposed in one end of the pump cylinder (519), the other two ends of the pump cylinder (519) are communicated with the water outlet nozzle (525) and the water inlet nozzle (514), one end of the piston rod (520) is connected with the pumping piston head (527), and the other end of the piston rod (520) eccentrically and rotationally cooperates with the contrate gear (522).

2. The pump structure of a portable oral irrigator of claim 1, wherein an end surface of the contrate gear (522) is provided with an eccentric shaft (523), the other end of the piston rod (520) is provided with a shaft sleeve (521), and the shaft sleeve (521) is sheathed on the eccentric shaft (523), the water outlet (51) is located at a top end of the housing (512), and the water outlet nozzle (525), the pump cylinder (519) and the driving motor (57) are sequentially disposed from top to bottom.

3. The pump structure of a portable oral irrigator of claim 1, wherein the housing (512) is in a sleeve shape with an open bottom end, the water inlet (52) and the water outlet (51) are respectively disposed at a top end and an outer periphery of the housing (512), a storage battery (59), a control circuit board (58) and a wireless charging module (511) are also disposed within the housing (512), the storage battery (59), the control circuit board (58), the wireless charging module (511) and the pump assembly are packaged within the housing (512) by means of a bottom cover (510), and the bottom cover (510) is hermetically connected with a lower end of the housing (512); the storage battery (59) is respectively electrically connected with the control circuit board (58) and the wireless charging module (511), and the control circuit board (58) is electrically connected with the driving motor (57); and the storage battery (59) and the wireless charging module (511) are sequentially disposed below the driving motor (57).

4. The pump structure of a portable oral irrigator of claim 3, wherein a front bracket (56) and a rear bracket (513) are also disposed within the housing (512), the pump assembly, the storage battery (59) and the wireless charging module (511) are located between the front bracket (56) and the rear bracket (513), and the control circuit board (58) is disposed at a front side of the front bracket (56), the control circuit board (58) is provided with a button control switch, and the housing (512) is provided with a waterproof button (53) corresponding to the button control switch.

5. A portable oral irrigator , wherein the portable oral irrigator comprises the pump structure of claim 1, the portable oral irrigator comprises a charging seat, the charging seat comprises a seat body (1), a wireless charging circuit and a power wire, a top part of the seat body (1) is provided with a main engine positioning groove (11) for placing the oral irrigator main engine (5), the wireless charging circuit is disposed within the seat body (1) and is electrically connected with one end of the power wire, the other end of the power wire extends out of the seat body (1) and is connected with a plug, the outer periphery of the seat body (1) is provided with a winding groove (18) for winding the power wire, and a bottom part of the seat body (1) is provided with a plug accommodating groove (111).

6. The portable oral irrigator of claim 5, wherein a lower side of the winding groove (18) is provided with a cover plate (17), a surface of the cover plate (17) is provided with a wire through opening (110) which penetrates through upper and lower sides of the cover plate (17) and is communicated with the plug accommodating groove (111), one side of the plug accommodating groove (111) is provided with a finger relief groove (112), and the finger relief groove (112) is communicated with the plug accommodating groove (111).

7. The portable oral irrigator of claim 5, wherein the portable oral irrigator comprises a flexible pipe bracket (7) and a pumping flexible pipe (8), a pipe winding groove is disposed outside the flexible pipe bracket (7), one end of the pumping flexible pipe (8) is connected with a filter head (82), the pipe winding groove is provided with a filter head anti-release clamping position (78) corresponding to the filter head (82), and is also provided with a flexible pipe anti-release clamping position (73) corresponding to the other end of the pumping flexible pipe (8), the pumping flexible pipe (8) is wound outside the pipe winding groove, the filter head (82) at one end of the pumping flexible pipe (8) is clamped in the filter head anti-release clamping position (78), and the other end of the pumping flexible pipe (8) is clamped in the flexible pipe anti-release clamping position (73).

8. The portable oral irrigator of claim 7, wherein the flexible pipe bracket (7) is composed of a strip-shaped first side plate (72), a second side plate (74) and a middle connecting plate (71), left and right ends of the middle connecting plate (71) are respectively connected with the first side plate (72) and the second side plate (74) to form an I-shaped structure, and an inside of the I-shaped structure forms the pipe winding groove; and upper and lower ends of the middle connecting plate (71) are respectively provided with a first flexible pipe clamping groove (76) and a second flexible pipe clamping groove (77); the filter head (82) comprises a housing (83) and a filter element (841), the housing (83) is wrapped outside the filter element (841) and is provided with a water inlet hole (832) corresponding to the filter element (841), and an insertion groove (831) is disposed in a surface of the housing (83); and one end of the filter element (841) is provided with a water outlet nozzle (84) which extends out of the housing (83) and is connected with the pumping flexible pipe (8).

9. The portable oral irrigator of claim 5, wherein an inner wall of the water inlet (52) is provided with a sealing ring (10) which is clamped between the water inlet nozzle (514) and an inner wall of the housing (512), and a center of the sealing ring (10) is provided with a sleeve pipe (102) extending inside the water inlet nozzle (514); a nozzle can be disposed on the water outlet (51) of the oral irrigator main engine (5), the nozzle comprises a nozzle body (6), the nozzle body (6) sequentially comprises a connecting head (63), a nozzle handle (61) and a nozzle head (66) from bottom to top, the nozzle body (6) is internally provided with a water flow channel (611), the nozzle head (66) is provided with an injection hole (68) communicated with the water flow channel (611), the nozzle head (66) is externally provided with a soft sleeve (69), the soft sleeve (69) covers to an outer periphery of the nozzle head (66) and a top end thereof, the soft sleeve (69) is provided with a relief hole (610) corresponding to the injection hole.

10. The portable oral irrigator of claim 5, wherein an inner wall of the water inlet (52) is provided with a sealing ring (10) which is clamped between the water inlet nozzle (514) and an inner wall of the housing (512), and a center of the sealing ring (10) is provided with a sleeve pipe (102) extending inside the water inlet nozzle (514); an oral brush can be disposed on the water outlet (51) of the oral irrigator main engine (5), the oral brush comprises a brush body (9), two ends of the brush body (9) are respectively provided with a connecting head (91) and a brush head (96), wherein the brush body (9) is internally provided with a water flow channel (97), one side of the brush head (96) is provided with a water spray hole (95) and a conical bristle bundle (94), the connecting head (91) and the water spray hole (95) are both communicated with the water flow channel (97), the conical bristle bundle (94) is composed of a plurality of bristles, one end of the conical bristle bundle (94) is disposed in the brush head 96, and the other end of the conical bristle bundle (94) is conical.
